(19) United States
(12) Patent Application Publication
(10) Pub. No.: US 2014/0173591 A1
(43) Pub. Date: Jun. 19, 2014

(54) DIFFERENTIATED SERVICE LEVELS IN VIRTUALIZED COMPUTING

(71) Applicant: CISCO TECHNOLOGY, INC., San Jose, CA (US)

(72) Inventors: Shyyunn Sheran Lin, San Jose, CA (US); Subrata Dasgupta, San Jose, CA (US); Peter Nightingale, Cary, NC (US); Sanjeev Ukhalkar, Fremont, CA (US); Anil Vasireddy, Santa Clara, CA (US)

(73) Assignee: Cisco Technology, Inc., San Jose, CA (US)

(21) Appl. No.: 13/713,460

(22) Filed: Dec. 13, 2012

(51) Int. Cl. G06F 9/455

(52) U.S. Cl. CPC G06F 9/455
USPC 718/1

(57) ABSTRACT

In one implementation, a host provides virtualized computing to one or more customer networks. The virtualized computing may include hardware virtualization quantified in the resources of the virtual machines, services virtualization quantified in the quantity or types of services performed on host, or processing virtualization quantified by process occurrences. When the host receives a request for computing virtualization from a user device, the host derives an authentication value and accesses a virtualization service level from a memory. The host is configured to deliver the computing virtualization to the user device according the virtualization service level.

### TECHNICAL FIELD

This disclosure relates in general to the field of virtualization of computing and, more particularly, to offering differentiated service level agreements in virtualized computing environments.

### BACKGROUND

Virtualization is the creation of a virtual equivalent of an actual hardware or software component. Hardware virtualization may simulate a platform, a storage device, a network resource, an operating system or another component. A virtual machine is a software instance that acts similar to a physical computer with an operating system. The virtual machine may execute software separated from the underlying hardware.

Hardware virtualization involves host machines and guest machines. A host machine is the physical machine on which the hardware virtualization occurs. A guest machine is the virtual machine created by the host machine. Hardware resources may be separated in hardware virtualization into virtualized infrastructure services such as CPU, memory, and storage.

Previously, every operating system required a physical server. However, the separation of the operating system from the physical hardware allows multiple guest machines to run on a single host machine. Further, hardware virtualization provides can run guest machines from multiple customers on a single host machine.

### BRIEF DESCRIPTION OF THE DRAWINGS

Exemplary embodiments of the present embodiments are described herein with reference to the following drawings.

FIG. 1 illustrates an example of computing virtualization.

FIG. 2 illustrates an example of differentiated service delivery in computing virtualization.

FIG. 3 illustrates an example of factory subsystem implementation of computing virtualization.

FIG. 4 illustrates an example network device for computing virtualization.

FIG. 5 illustrates an example flowchart for differentiated service levels in computing virtualization.

### DESCRIPTION OF EXAMPLE EMBODIMENTS

### Overview

In one example, a method includes receiving a request for computing virtualization from a user device, deriving an authentication value from the request, and accessing a virtualization service level from a memory according to the authentication value. The virtualization service level is selected from a plurality of virtualization service levels. The computing virtualization is delivered to the user device according the virtualization service level.

In another example, an apparatus includes a communication interface, a memory, and a controller. The communication interface is configured to receive a request for a virtualization of hardware, resources, or services from a user device. The memory is configured to store a plurality of virtualization service levels each specifying a service level for the virtualization. The controller is configured to access a virtualization service level from the plurality of virtualization service levels stored in memory according to a service level agreement with the user device and assign the virtualization service level to the user device.

In another example, a non-transitory computer readable medium contains instructions that when executed are configured to, receive a data packet for computing virtualization from a customer network, query a service level database based on the customer network, receive a virtualization service level from the service level database, wherein the virtualization service level is selected from a plurality of virtualization service levels and the virtualization service level defines resources allocated to the customer network, and provide the computing virtualization to the customer network according the virtualization service level.

### Example Embodiments

The disclosed embodiments relate differentiated service levels in computing virtualization. Computing virtualization may take the form of hardware virtualization, services virtualization, or processing virtualization. Hardware virtualization includes the formation of a virtual machine logically described and quantified in terms of hardware components. Services virtualization, which may be referred to as application virtualization, includes network applications for a local customer network performed elsewhere and delivered as a service. Processing virtualization includes data communication related utilities performed by the service provider for the customer network.

The hosting environment for the computing virtualization may be defined according to a factory model. On a structural level, the hosting environment includes servers and computing devices. The hosting environment may be in one location or distributed across various locations and may include third party infrastructure suppliers. On a logical level, the hosting environment is divided into factories. A factory is a virtualized platform consisting of one or more virtual CPUs, virtual memory, and virtual storage. The factory allows the resources of the hosting environment to be commoditized. The virtualized platform may be configured to run an operating system and software through the operating system.

The differentiated service levels are defined by service level agreements. The hosting environment supplies different levels of computing virtualization to various customers according to the service level agreements. The differentiated service levels may include service levels for one or more of hardware virtualization, services virtualization, or processing virtualization.

Hardware virtualization includes the formation of a virtual machine logically described and quantified in terms of hardware components. A service level may define the type of hardware resource pool available to a customer. The term customer may refer to a set of customer network devices. The service levels may include a highest level in which the customer has a dedicated resource pool of processors, memory, and storage. The service levels may include a high level where the customer has priority access to resource pools but shares the resources with other high level customers. The service levels may include a medium level in which the customer has accesses to resource pools as they become available. The service levels may include a low level in which the customer has access to resource pools only after all other service levels receive access. The service level may determine how much of each hardware resource is allocated to a factory, and in turn, to a specific set of customer devices. For example, the virtualized hardware may specify a predetermined memory level (e.g., a random access memory defined in any number of megabytes or gigabytes), a predetermined central processing unit level (e.g., CPU defined by clock speed, cycles per second, or bogomips), and a predetermined storage level (e.g., defined in gigabytes or terabytes).

Services virtualization, which may be referred to as application virtualization, includes network applications for a local customer network performed elsewhere and delivered as a service. Network applications include data backup, data restoration, disaster recovery, data encryption, geographic data center deployments, customer assignments, affinity to resource pools, and data aggregation services. The service levels for services virtualization are related to the priority of the applications and the number of devices processed. The service level number of devices processed may be defined per unit time. An example highest level of service virtualization may include at least 10,000 devices processed per hour, an example high level may include at least 9,000 devices processed per hour, an example medium level may include at least 6,000 devices per hour, and an example low level may include 3,000 devices processed per hour. Other examples are possible and any level of the number of devices processed per hour may be defined by the service level agreements and delivered by the hosting environment.

Processing virtualization includes data communication related utilities performed by the service provider for the customer network. Utilities performed by the service provider may include round trip request latency, backend service processing turnaround time, scheduling of requests, and prioritization of requests. The requests may be requests for network devices on the customer network to be analyzed. The service levels for processing virtualization may include a highest level in which the customer can readily access the application processing status and request reports on demand for the network application. The service levels for application virtualization may include a high level in which application processes are at a priority but reports are available only within a time constraint (e.g., daily, weekly). The service levels for application virtualization may include a medium level in which application processes are at a low priority and reporting is available infrequently (e.g., weekly, monthly). The service levels for application virtualization may include a low level in which application processes are at a lowest priority and reporting is available only after inventory processing is finished.

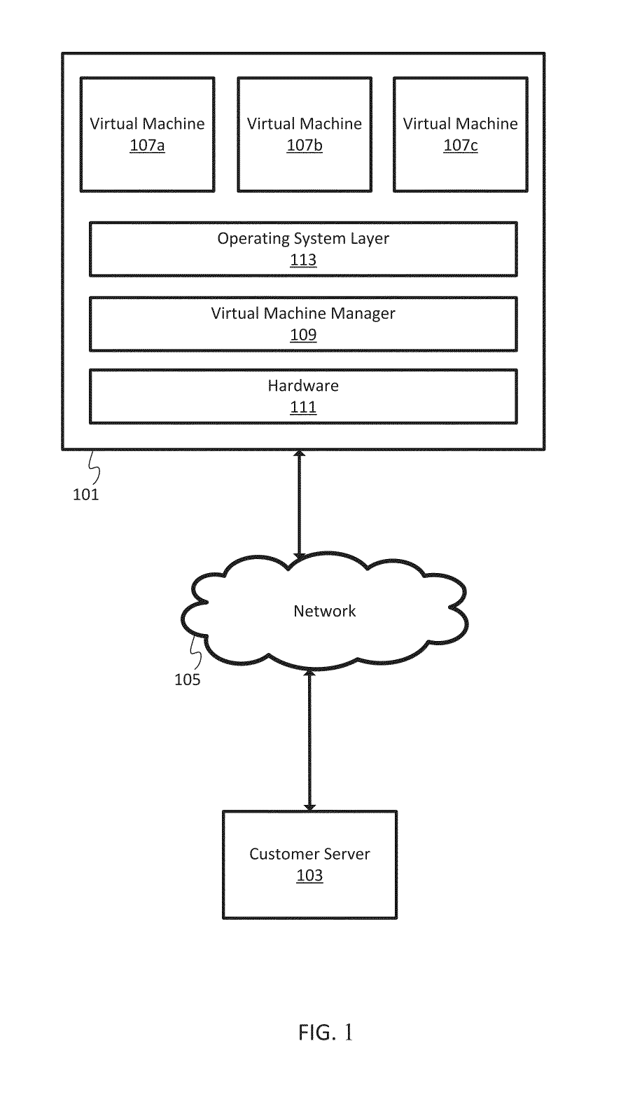

FIG. 1 illustrates two core tenants of modern computing: virtualization and distribution. A customer device, such as customer server 103 communicates with the host 101 by way of network 105. The host environment includes virtual machines 107a-b, a virtual machine manager 109 (e.g., hypervisor), and hardware 111. The hosted services platform 101 may be a server running the virtual machine manager 109 as software. The server is physical hardware, including at least a processor and memory, configured to run virtual machines 107a-c through the virtual machine manager 109, which allows for the server to share physical resources such as the processor, the memory, and storage among the virtual machines 107a-b.

The virtual machine manager 109 provides a map between the virtual resources in virtual machines 107a-b and the physical resources of the server. The virtual machine manager 109 is configured to communicate directly with the underlying physical server hardware. The resources are assigned to the virtual machines 107a-b. Alternatively, the virtual machine manager 109 may be loaded on top of an operating system running on the physical server hardware.

The customer server 103 sends a request for virtualization to the hosted services platform 101. The request may be a command to set up a virtual machine. The request may be an operation for the virtual machine. The operation may be any instruction, originating on the customer server 103, which operates the software running on the virtual machine.

The request may include an authentication value. The authentication value identifies the customer server 103 to the hosted services platform 101. The authentication value may be an alphanumeric character string (e.g., serial number, address) that uniquely identifies the customer server 103. The authentication value may be more sophisticated, including a password, token, or a pretty good privacy (PGP) data encryption key. The hosted services platform 101 is configured to access a virtualization service level from a memory according to the authentication value.

The virtualization service level is selected from multiple virtualization service levels. The hosted services platform 101 is configured to deliver the virtualization of the resource according the virtualization service level. The service levels include at least a low service level and a high service level. One factory pool may be associated with the low service level and another factory pool may be associated with the high service level.

In one example, the computing virtualization may be network analytics. Network analytics are programs and applications that run on hosted platforms and provide network administration to local networks (e.g., the network including customer server 103). Network analytics may include management software that collects data from network devices on the local network. The service level may have multiple components, which are each tied to an aspect of network analytics. For example, a service level for the device processing rate may define how many devices are processed per unit time (devices processed per hour). A service level for the response time to user requests may define the round trip web services request latency. A service level for the upload frequency defines how often and when uploads can occur. The uploads are a collection of network devices include CLI (command line interface) and MIB (management information base) information regarding the inventory and configuration information for the network devices. The information is collected via a collector, which may be a program installed on an appliance at a customer location. Collectors use seedfile information or discovery protocols to communicate to the devices in the customers' network and collect inventory and configuration information, and then upload the data to the factories where the network analytics program runs. The network analytics program process those information and generate report. The collection can be run periodically or on demand.

Network analytics may also include other types of services. For example, the computing virtualization may analyze the local network to determine optimal settings for a network device on the local network. Any or all of these network analytics may be run in a virtualized factory platform.

The virtualization service level may define specific attributes of how the customer devices receive services from the virtual machines on hosted services platform 101. The virtualization service level may specify a queue priority for a customer device. The queue priority defines an order with respect to other devices, that requests from a specific customer device are handled. The queue priorities may be ranked (e.g., integers 1 through 10). The virtualization service level may specify a backup frequency for the data associated with the customer device. Example backup frequencies include (e.g., every 10 minutes, hourly, twice a day, daily, weekly, or any other time period).

The virtualization service level may specify how many customer devices can share a factory pool. As more customer devices share a customer pool, fewer resources can be allocated to any one customer device. Example resource sharing pool sizes for a factory pool include 10 devices, 1000 devices, 10000 devices, or any other number of devices.

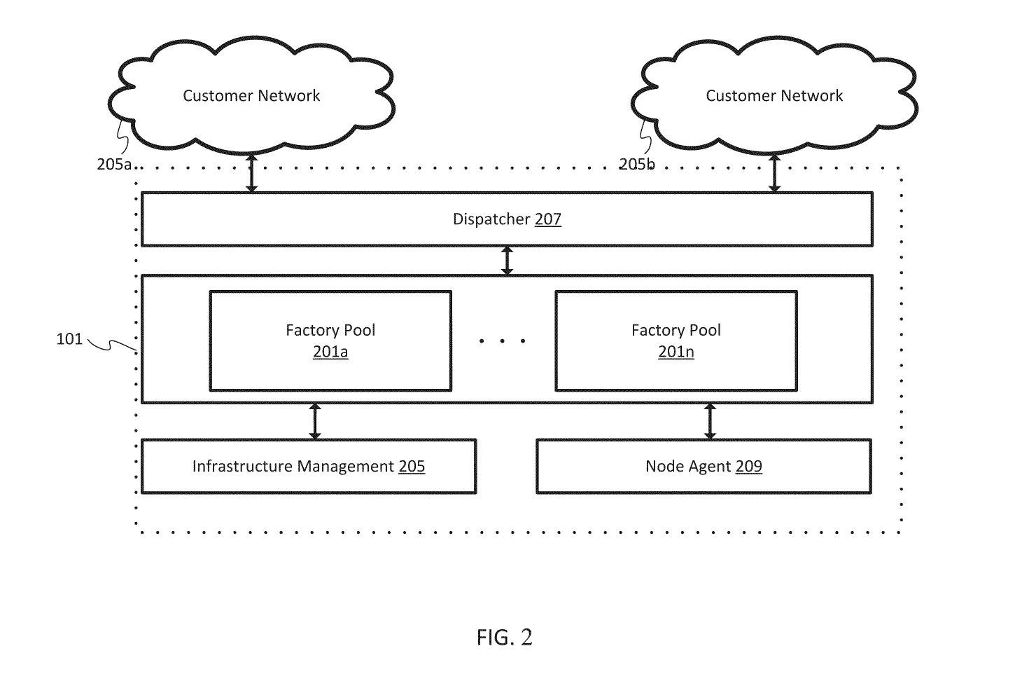

FIG. 2 illustrates an example of differentiated service delivery in computing virtualization. The hosted services platform 101 includes physical hardware of a network device, including at least a processor, memory, and a communication interface. The hosted services platform 101 is divided into pools of factory pools 201a-n, a dispatcher portion 207, a node agent 209 and infrastructure management portion 205. Any number of factory pools 201a-n may be included. The hosted services platform 101 is coupled with multiple customer networks 205a-b via the communication interface.

The hosted services platform 101 stored in memory a lookup table associating customer devices and/or customer networks with service levels. The lookup table may match or pair addresses of customer devices with service levels. In one example, the service levels may be broadly characterized (e.g., low, medium, and high). In another example, the service levels may be specified for different types of virtualization (e.g., resources, applications, and processes). In another example, the service levels may be specific to individual functions of the virtual machines, which are described in more detail below. The lookup table may also associate the service level and customer device pairs with a factory pool, which defines physical resources of the virtual machine. Each of the factory pools may be provisioned on the hosted services platform 101 according to a configuration file. The configuration file may include an initial allocation for a CPU level, a memory level, and a storage space level for the factory pool.

The dispatcher portion 207 may be implemented as an application running on the hosted services platform 101. The dispatcher portion 207 is responsible for managing the mapping of customers to factories and directing all network traffic for a specific customer to a specific factory pool. The dispatcher portion 207 enables groups of customer devices to maintain affinity to a set of factories with differentiated service level agreements. For example, when a customer device is added, the dispatcher 207 receives a request from the customer device for the computing virtualization. The dispatcher 207 determines what factory pool that the new customer device belongs to.

The node agent 209 may be implemented as software running on the hosted services platform 101. The node agent 209 is configured to monitor the utilization of hardware resources as well as network traffic and health of deployed services. The node agent 209 monitors the factory. More specifically, the node agent 209 monitors the a load of the CPU and amount of memory that is free in order to insure that one or more service levels specified for the customer devices associated with the factory are met. For example, the node agent may determine if any resources are over utilized. In addition, the node agent may be configured to determine whether the processes and the services are up and running.

The infrastructure management portion 205 includes software configured to manage the hosted services platform 101. The infrastructure management portion 205 is configured to perform platform and services level health checks, enables fault detection and fault repair, adjustment of resources such as adding more CPU, memory, heap size of deployed services, auto tuning of database parameters, message prioritization, creation of new factories, rebalancing users running in a cluster of factories.

For example, for the service level for the device processing rate, the infrastructure management portion 205 includes a timer to monitor and record the inventory upload time along with inventory size. The infrastructure management portion 205 may determine that the required service level may not be reached based on current trends. In order to guarantee the required service level, the infrastructure management portion 205 adds resources dynamically into the factory. In the alternative or in addition, the infrastructure management portion 205 may be configured to rebalance the factory. For example, customers may be moved from one factory pool to another or factories may be added to the factory pool in need.

As another example, the service level for the round trip web services request latency may be monitored by the infrastructure management portion 205. For example, the timer of the infrastructure management portion 205 may record time stamps for user requests received from user devices. If the round trip web services request latency falls beneath a threshold defined in the service level agreement, the infrastructure management portion 205 may rebalance the factories. Among other things, rebalancing the factories may include adding or removing resources from a factory pool, adding or removing factories from a factoring pool, or moving customers from one factory pool to another. In addition, the infrastructure management portion 205 may be configured to migrate users to other geographic factories closer to the geographic location of respective users.

As another example, the service level for upload frequency may be defined by the infrastructure management portion 205. The scheduling of requests with respect to network inventory upload may be limited to a predetermined time frequency. Time frequencies include hourly, daily, weekly, monthly, or any unit of time.

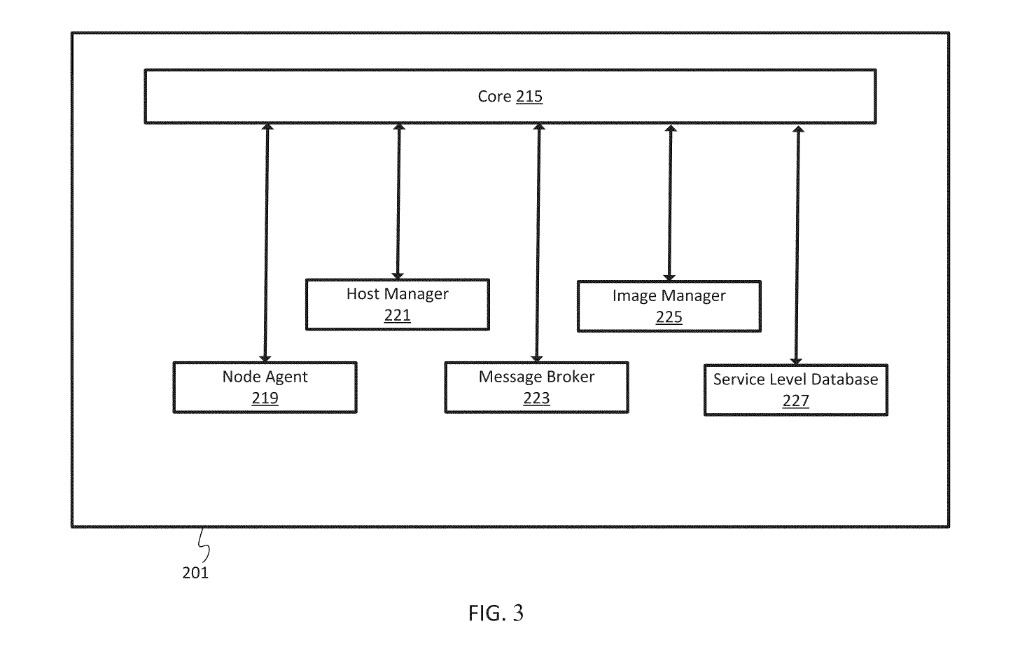

FIG. 3 illustrates an example of factory subsystem 201. The factory subsystem 201 is a unit of a factory pool 201a-n and implemented using the hardware of hosted services platform 101. A factory subsystem 201 may be included for each of the factories in a pool. The factory subsystem 201 includes a core controller 215 in communication with a node agent component 219, a host manager component 221, a message broker 223, an image manager 225, and a service level database 227.

The message broker component 223 is a java application that formats and exchanges messages between processes in the hosted services platform. . The message broker 223 is configured to receive a data packet for computing virtualization from a customer network.

The core controller 215 is configured to query the service level database 227 based on an identity of the customer network encoded in the data packet received by the message broker 223. The core controller 215 receives a virtualization service level from the service level database and provides the computing virtualization to the customer network according the virtualization service level.

The node agent component 219 is configured to communicate with the node agent 209. The node agent component 219, or alternatively the core controller 215, is configured to monitor the processing and memory resources included in the resources allocated to the customer network to determine whether the virtualization service level has been met. The node agent component 219 communicates these determinations to the node agent 209 of the hosted services platform 101 in order to monitor the entire factory pool or multiple factory pools.

The host manager component 221 is configured to communicate with the infrastructure management 205. The host manager component 221 reports the processes performed in the factor to the infrastructure management 205 so that resources may be added to the factory or factories may be rebalanced.

The image manager component 225 enables management of images, which are static data containing the operating system, the applications, and configurations of the virtual machine. The image manager component 225 may manages packages or platform components such as java development kit (JDK), or a relational database management system (RDBMS). The image manager component 225 may be configured to create, read, update, and delete (CRUD) the bootstrapped image (e.g., add existing package to an image, add an application or other application artifact to an image).

The service level database 227 stores multiple virtualization service levels that define resources allocated to various customer networks. The service level database 227 may include a table correlating customer network addresses to service levels. The services levels may be distinguished in various ways. For example, each service level may include a service sublevel in virtualized resources, virtualized services, and virtualized processing. In the virtualized resource category, the service sublevel defines CPU resources, memory resources and storage resources. In the virtualized services category, the service sublevel includes data backup and restore, disaster recovery, data encryption, geographic data center deployments, customer assignments and affinity to resource pools, and data aggregation services. In the virtualized processing category, the service sublevel includes round trip request latency, backend service processing turnaround time, scheduling of requests and throttling of requests.

In addition or in the alternative, service level database 227 stores service offerings in packages. For example, the service level database 227 may store a platinum package, a gold package, a silver package, and a bronze package.

The platinum package may offer dedicated virtual hardware resources. A customer network associated with a platinum package has undivided use of a factory or pool of factories including one or more dedicated CPUs, memory, and databases. The platinum package may offer on-demand report. That is, the customer network is permitted to request application processing status and other reports generated at any time during processing. Workloads or requests from customer networks with the platinum package are not queued behind other users of the host 101. In the network analytics example, the platinum package may also specify a high number of devices processed per unit time (e.g., a minimum of 10,000 devices per hour). In addition or in the alternative, the platinum package may place a low limit (e.g., 3,000, a few thousand, or another range) on the number of devices allocated to a factory or a factory pool. The platinum package may allow the customer network to perform unlimited uploads per month and define a time period for backup such as every 8 hours.

The gold package may lack dedicated virtual hardware resources but instead a premium set of shared resource pools. The premium set of shared resources pools is defined by a predetermined ratio of network devices to virtualized resources that is fairly low. Example ratios include 50,000, 100,000, 150,000, and 200,000 devices per factory. In the network analytics example, the gold package may specified a minimum number of devices processed (e.g., 8,000 devices per hour) and a median number of devices processed (e.g., 9,000 devices per hour). In addition or in the alternative, the gold package may place a limit (e.g., 200,000 or another range) on the number of devices allocated to a factory or a factory pool. The gold package may allow the customer network to perform a limited number (e.g., 30, 50) of uploads per month and define a time period for backup (e.g., 24 hours).The silver package may lack dedicated virtual hardware resources or premium shared resources. Instead, customer device associated with the silver package receive a batch mode processing. The batch mode processing refers to the processing of requests or customer uploads that have been received by the factory but are in queue. Such requests or uploads are in queue because other higher priority requests are being processed. When the higher priority customers' loads are finished, the lower priority requests are processed. In the network analytics example, a low minimum number of devices processed (e.g., 6,000 devices per hour) is specified by the service level database 227 and a low guarantee for the minimum average (e.g., 7,000 devices). In addition or in the alternative, the silver package may place a high limit (e.g., 1 million, or another range) on the number of devices allocated to a factory or a factory pool. The silver package may allow the customer network to perform a lower number (e.g., 4, 10) of uploads per month and define a less frequent period for backup (e.g., weekly).

The bronze package also may include only a batch mode processing. The bronze package may specify a lower minimum for device processing guarantee (e.g., 3,000 devices per hour) and a lower median (e.g., 4,000 devices per hour). The bronze package may limit customer networks to a very low number (e.g., 1, 2) of uploads per month. Customer networks on the bronze package may only be able to requests reports after the batch process finished. In addition or in the alternative, the bronze package may place a very high limit (e.g., 5 million, or another range) or no limit on the number of devices allocated to a factory or a factory pool. At the bronze service level, backups will be done every month or more infrequently.

Each factory or factory pool is assigned to a service level (e.g., platinum, gold, silver, or bronze). Each customer network or customer device is assigned to the factory pool associated with the respective service level. An optional dispatcher component is configured to communicate with the dispatcher 207 in order to manage the mapping of customer devices or networks to assigned factories and directing all network traffic for a specific customer device to a specific factory.

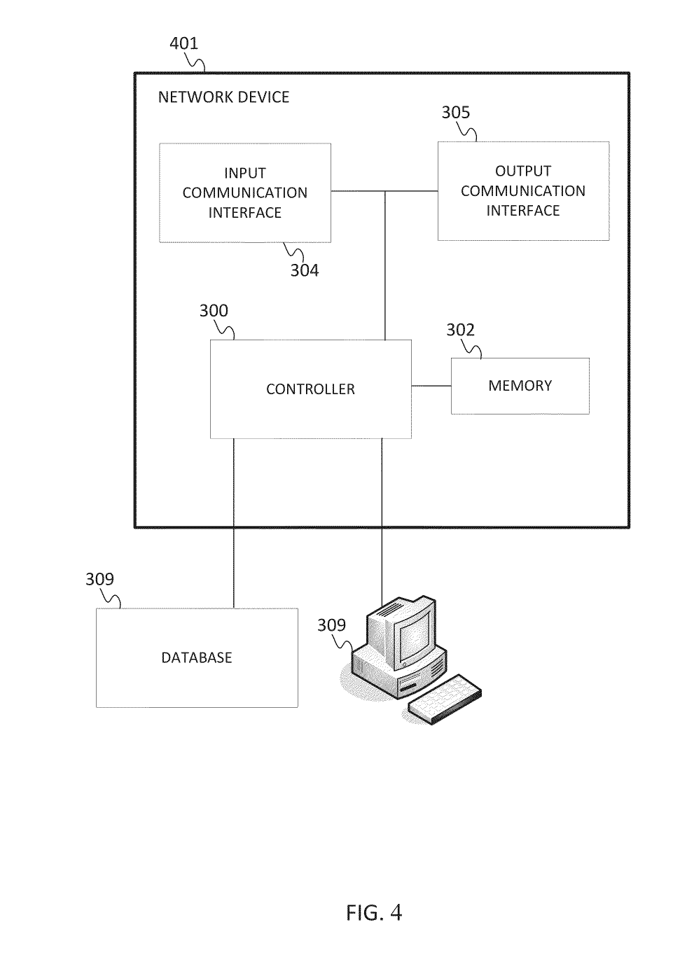

FIG. 4 illustrates an example network device 401 for computing virtualization. An example of the network device 401 is the hosted services platform 101. The network device 401 includes at least a controller 300, a memory 302, an input communication interface 304, and an output communication interface 305. The network device 401 may also communicate with a workstation 307 and a database 309. Additional, different, or fewer components may be provided.

The input communication interface 304 is configured to receive a request for a virtualization of hardware, resources, or services from a user device. The user device may be an endpoint or other network device on a customer network. The memory 302 or database 309 may store a lookup table that associates the user device or the customer network with virtualization service levels each specifying a service level for the virtualization.

The controller 300 is configured to access a virtualization service level from the plurality of virtualization service levels stored in memory. The virtualization service level is defined according to a service level agreement with the user device. The controller 300 assigns the virtualization service level to the user device so that resources are delivered to the user device according to the virtualization service level.

The controller 300 may be configured to run an operating system (e.g., Linux, Windows NT). The operating system runs software requested by the user device. The operating system may also run management software as described above.

The controller 300 may include a general processor, digital signal processor, an application specific integrated circuit (ASIC), field programmable gate array (FPGA), analog circuit, digital circuit, combinations thereof, or other now known or later developed processor. The controller 300 may be a single device or combinations of devices, such as associated with a network, distributed processing, or cloud computing.

The memory 302 may be a volatile memory or a non-volatile memory. The memory 302 may include one or more of a read only memory (ROM), random access memory (RAM), a flash memory, an electronic erasable program read only memory (EEPROM), or other type of memory. The memory 302 may be removable from the network device 101, such as a secure digital (SD) memory card.

In addition to ingress ports and egress ports, the input communication interface 304 and the output communication interface 305 may include any operable connection. An operable connection may be one in which signals, physical communications, and/or logical communications may be sent and/or received. An operable connection may include a physical interface, an electrical interface, and/or a data interface.

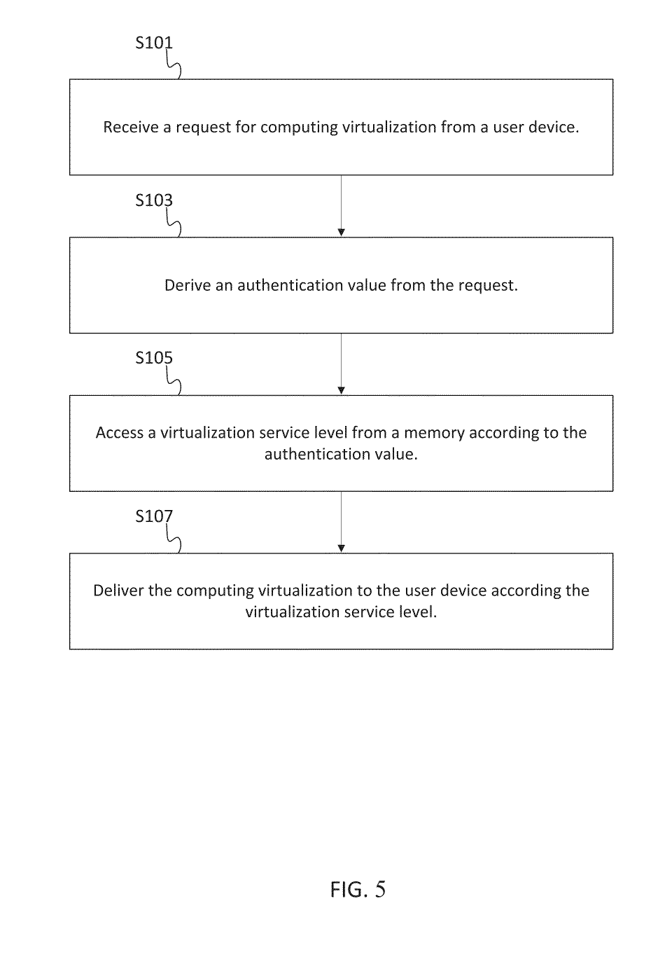

FIG. 5 illustrates an example flowchart for differentiated service levels in computing virtualization using logical factories. This factory concept for the hosting environment and the mechanism to offer differentiated customer service level agreements for computing virtualization resources, services, and processes. In one example, network analytics applications for local networks are implemented using these factories. The hosting environment may be one or more host servers and may be deployed in various geographical or network locations including data centers and third party infrastructure providers.

At act S101, the controller of hosted services platform 3.01 is configured to receive a request for computing virtualization from a user device. The controller may receive the request directly or the host may receive the request through the communication interface. The request is either a command to provision or create a virtual machine or a request to perform an operation within a virtual machine. The operation within a virtual machine may relate to a hosted application specified by the user device or relate to a process or service offered by the host, such as an analysis of a network associated with the user device.

At act S103, the controller is configured to determine an authentication value from the received request. The authentication value may be an identification number of the user device. The authentication value may be a security key or a password that authenticated the user device as an authorized user of the virtualized computing resources, applications, or processes performed or provisioned on hosted services platform 101.

At act S104, the controller is configured to access a virtualization service level from a memory according to the authentication value. Possible service levels may be organized in classifications that are associated with respective factory pools. For example, one factory pool is assigned to a lowest service level, which receives virtualized computing resources only at off peak times. Another factory pool is assigned to a highest service level, which receives virtualized computing resources at any time and trumps user devices assigned to other service levels. Another factory pool is assigned to a medium service level, which receives virtualized computing resources when no priority user devices are requesting virtualized computing resources. The controller determines which factory or which factory pool the user device is associated with through the authentication value and/or an identification value.

At act S107, the controller is configured to deliver the computing virtualization to the user device according to the virtualization service level. The controller delivers the computing virtualization by assigning physical resources of the host 101 to the request of the user device.

The preceding embodiments allow customer networks the choice of different service levels for network analytics applications. The service levels may be based on hardware, service schedule, and/or application performance, which provide advantages over the one size fit all approach for most of the hosted network analytic applications. The preceding embodiments opens virtualization computing to customers better matched with low cost and low priority performance, resources, storage and network usage, which increases the market segment for virtualization. The preceding embodiments provide flexibility to customers to modify service levels without downtime as their network size grow or demand increased.

The network may include wired networks, wireless networks, or combinations thereof. The wireless network may be a cellular telephone network, an 802.11, 802.16, 802.20, or WiMax network. Further, the network may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored. The computer-readable medium may be non-transitory, which includes all tangible computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

As used in this application, the term ‘circuitry’ or ‘circuit’ refers to all of the following: (a)hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Processors suitable for the execution of a computer program include, by way of example, both general and special purpose microprocessors, and anyone or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

We claim:

1. A method comprising:
receiving a request for computing virtualization from a user device;
accessing, from a memory, a virtualization service level according to the user device, wherein the virtualization service level is selected from a plurality of virtualization service levels; and
delivering the computing virtualization to the user device according the virtualization service level.

2. The method of claim 1, wherein the virtualization service level specifies a queue priority with respect to other user devices and the queue priority is selected from a plurality of queue priorities.

3. The method of claim 1, wherein the virtualization service level specifies a backup frequency for the computing virtualization.

4. The method of claim 1, wherein the virtualization service level specifies a resource sharing pool size.

5. The method of claim 1, wherein the virtualization service level specifies a frequency for report generation and delivery to the user device.

6. The method of claim 1, wherein the computing virtualization is virtualized hardware including a predetermined memory level, a predetermined central processing unit level, and a predetermined storage level.

7. The method of claim 1, wherein the computing virtualization is a virtualized service.

8. The method of claim 7, wherein the virtualized service is selected from a data backup service, a data restore service, a disaster recovery service, a data encryption service, and a data aggregation service.

9. The method of claim 1, wherein the computing virtualization is a virtualized process.

10. The method of claim 9, wherein the virtualized process defines a round trip request latency, a backend service processing turnaround time, or a schedule of the virtualized process.

11. An apparatus comprising:
a communication interface configured to receive a request for a virtualization of hardware, resources, or services from a user device;
a memory configured to store a plurality of virtualization service levels each specifying a service level for the virtualization; and
a controller configured to access a virtualization service level from the plurality of virtualization service levels stored in memory according to a service level agreement with the user device and assign the virtualization service level to the user device.

12. The apparatus of claim 11, wherein the virtualization is network analytics.

13. The apparatus of claim 12, wherein the virtualization service level specifies a minimum number of devices to be processed in the network analytics.

14. The apparatus of claim 12, wherein the virtualization service level specifies a time period for backing up the user device.

15. The apparatus of claim 12, wherein the virtualization service level specifies a time frequency for requesting network analytics reports.

16. The apparatus of claim 11, wherein the virtualization service level specifies a resource sharing pool size.

17. The apparatus of claim 11, wherein the virtualization service level specifies a quantity of processing resources and a quantity of memory resources allocated to the user device.

18. A non-transitory computer readable medium containing instructions that when executed are configured to:
receive a data packet for computing virtualization from a customer network;
query a service level database based on the customer network;
receive a virtualization service level from the service level database, wherein the virtualization service level is selected from a plurality of virtualization service levels and the virtualization service level defines resources allocated to the customer network; and
provide the computing virtualization to the customer network according the virtualization service level.

19. The non-transitory computer readable medium of claim 18, wherein the instructions are configured to:
monitor processing and memory resources included in the resources allocated to the customer network to determine whether the virtualization service level has been met.

20. The non-transitory computer readable medium of claim 18, wherein the virtualization service level is a high priority service level that overrides a previous or concurrent data packet for computing virtualization from a second customer network assigned to a low priority service level.
